(19) United States
(12) Patent Application Publication
(10) Pub. No.: US 2018/0125303 A1
(43) Pub. Date: May 10, 2018

(54) No Back Wash Colander

(71) Applicant: Karen Marie Ward, Warrenton, VA (US)

(72) Inventor: Karen Marie Ward, Warrenton, VA (US)

(21) Appl. No.: 15/345,474

(22) Filed: Nov. 7, 2016

(51) Int. Cl. A47J 43/24

(52) U.S. Cl. CPC A47J 43/24

(57) ABSTRACT

A no back wash colander system for providing a primary function of a colander system such as the separation of liquids from solids while simultaneously delivering user-safety features such as heat-resistant handles and hands-free colander base stabilization coupled with an absence of liquid backwash through a direct connection into a kitchen sink drain to further promote a sanitary environment for comestibles.

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. FIELD OF THE INVENTION

The present disclosure relates generally to the field of colander systems and more specifically relates to a no back wash colander system.

### 2. DESCRIPTION OF RELATED ART

A colander is a bowl-shaped kitchen utensil with holes in it used for draining food such as pasta or rice or to rinse vegetables. The perforated nature of the colander allows liquid to drain through while retaining the solids inside. It is sometimes also called a pasta strainer or kitchen sieve.

A colander is also used for separating wanted elements from unwanted material or for characterizing the particle size distribution of a sample, typically using a woven screen such as a mesh, net or metal for sifting. In cooking, a sifter is used to separate and break up clumps of dry ingredients, such as flour, as well as to aerate and combine them. A colander is also a form of a sieve, used to separate solids from liquid.

Stability is a highly sought and necessary feature in colander systems. Prior art colanders generally have a plurality of feet to act as a means of support and to assure stability on a horizontal surface as well as user safety, specifically when handling hot solids and liquids alike. Additionally, colanders generally have one or more handles for holding them, which is an equal safety concern in regards to handling hot solids or liquids. Prior art colanders have a variation of drawbacks. In general, these colanders are rigid and poorly adaptable to various operating conditions. Furthermore, many lack a variation of user safety features in combination.

Several attempts have been made to solve the above-mentioned problems such as those found in U.S. Pat. No. 3,170,175, U.S. Pat. No. 2,663,428, and U.S. Publication 2007/0295227. This art is representative of colander systems. However, none of the above disclosures, taken either singly or in combination, is seen to describe the invention as claimed.

### BRIEF SUMMARY OF THE INVENTION

In view of the foregoing disadvantages inherent in the known colander systems art, the present disclosure provides a novel no back wash colander system. The general purpose of the present disclosure, which will be described subsequently in greater detail is to provide a colander system which delivers user-safety features, including sanitization, while providing the primary function of enabling solids to be separated from liquids, and simultaneously providing a hands-free, stable colander system with an absence of liquid backwash through a direct connection into a sink drain.

A no back wash colander system is disclosed herein in a preferred embodiment, the no back wash colander system including a no back wash colander assembly having a conical-colander, a stem, and a base. The no back wash colander system comprises the no back wash colander assembly, wherein said no back wash colander assembly comprises in functional combination the conical-colander, the stem, and the base.

In this particular embodiment, the conical-colander comprises a top-opening, heat-resistant handles, a conical-wall, an inner volume, a sieve, and a bottom-opening. The functional combination of said conical-colander is to provide heat resistant handles for the purpose of user-safety, while allowing a combination of solids and liquids to be passed through the top-opening of the conical-colander where the top-opening is supported by a conical-wall, having an inner volume in which to contain a combination of solids and liquids, housing a sieve which serves to aid in the separation of such solids and liquids through perforated openings, whereas said sieve sits above the bottom-opening of the no back wash colander assembly to further enable the combined process of separating solids from liquids.

Additionally, the no back wash colander assembly comprises a stem having an upper end, a length, a lower end, and a circumference, wherein said stem serves as a conduit to release liquids through a side opening and into a sink drain to further prevent backwash, and to promote user-safety and sanitization.

Furthermore, the no back wash colander assembly may include a base, which is structured and arranged such that it is able to be independently set in a sink bottom such that when liquid is poured into said sink bottom through said no back wash colander system. The colander assembly may provide a sanitary environment for comestibles, particularly as excess water may be prevented from coming into contact with the edibles after coming into contact with a dirty sink.

A kit is also disclosed herein including: the no back wash colander assembly having and defined by a conical-colander having a top-opening, heat-resistant handles, a conical-wall, an inner volume, a sieve and a bottom opening, a stem having an upper-end, a length, a lower-end and a circumference, a base, and at least one set of user instructions.

The present disclosure holds significant improvements and serves as a colander system. For purposes of summarizing the disclosure, certain aspects, advantages, and novel features of the disclosure have been described herein. It is to be understood that not necessarily all such advantages may be achieved in accordance with any one particular embodiment of the disclosure. Thus, the disclosure may be embodied or carried out in a manner that achieves or optimizes one advantage or group of advantages as taught herein, without necessarily achieving other advantages as may be taught or suggested herein. The features of the disclosure which are believed to be novel are particularly pointed out and distinctly claimed in the concluding portion of the specification. These and other features, aspects, and advantages of the present disclosure will become better understood with reference to the following drawings and detailed description.

### BRIEF DESCRIPTION OF THE DRAWINGS

The figures which accompany the written portion of this specification illustrate embodiments and method(s) of use for the present disclosure, no back wash colander systems, constructed and operative according to the teachings of the present disclosure.

FIG. 1 shows a perspective view illustrating a no back wash colander according to an embodiment of the present disclosure.

FIG. 2 is a side perspective, cutaway view illustrating the no-back-wash-colander assembly of FIG. 1 according to an embodiment of the present disclosure.

FIG. 3 is a perspective view illustrating the no back wash colander system of FIG. 2 according to an embodiment of the present disclosure.

FIG. 4 is an exploded view illustrating the no back wash colander system, according to an embodiment of the present disclosure.

The various embodiments of the present disclosure will hereinafter be described in conjunction with the appended drawings, wherein like designations denote like elements.

### DETAILED DESCRIPTION

As discussed above, embodiments of the present disclosure relate to a colander system and more particularly to an elevated food strainer configured to reduce interaction with sink backwash, and to promote comestible sanitization of colander systems. Preferably, the elevated colander for evading back wash would provide no sink back wash interaction/contact, yet operate reliably, and be manufactured at a modest expense. Thus, a need exists for a reliable no back wash colander system to avoid the above-mentioned problems.

Generally speaking, a no back wash colander system may comprise a colander, or bowl-like structure with perforated holes, which may be in the form of a screen located in the base of a bowl-like structure. The colander may be elevated above a base, such as sitting on top of a 6″ hollow base stem, for example. Here, as liquid, or a combination of liquids and solids, is poured into the colander or bowl-like structure, down the 6″ hollow base stem, the water may be forced to rush down into the sink drain through an opening in at or near the lower portion of the hollow base stem. A sturdy base may be included, which is configured to prevent the colander system from tipping over on a horizontal surface. Furthermore, it may sufficiently sturdy to provide for hands-free operation, in regards to stabilization of the colander system. Advantageously, this configuration may eliminate liquid from rushing back up into the colander or bowl-like structure from a dirty sink, while maintaining complete separation of liquids and solids, while promoting comestible sanitization.

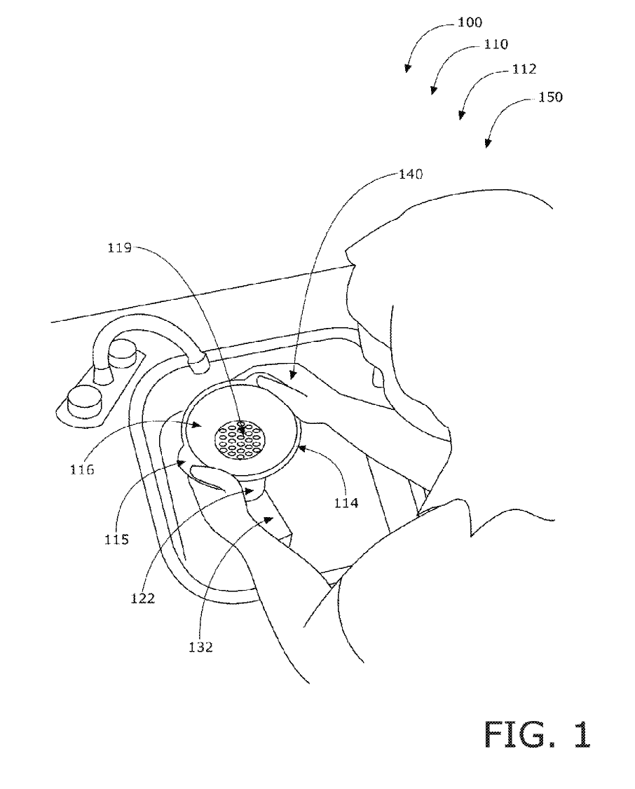

FIG. 1 shows a perspective view illustrating an elevated or “no back wash” colander system 100 including a no-back-wash-colander assembly 110 during an ‘in-use’ condition 150 showing a user 140 grasping a top-opening of a conical-colander 114 using heat-resistant handles 115 with both hands as the user places said no back wash colander system 100 directly over a kitchen sink drain according to an embodiment of the present disclosure.

As illustrated, the no back wash colander system 100 comprising a no-back-wash-colander assembly 110 during an “in-use” condition 150, where a user 140 is standing directly over a kitchen sink drain grasping at least two heat-resistant handles 115 of a conical-colander 112 having a top-opening 114 comprising a conical-wall 116 having an inner volume 118 with a water separator, such as screen 119, located at a bottom-opening 120 of said conical-colander 112, which sits atop a stem 122, which sits atop a base 132 in functional and structural combination.

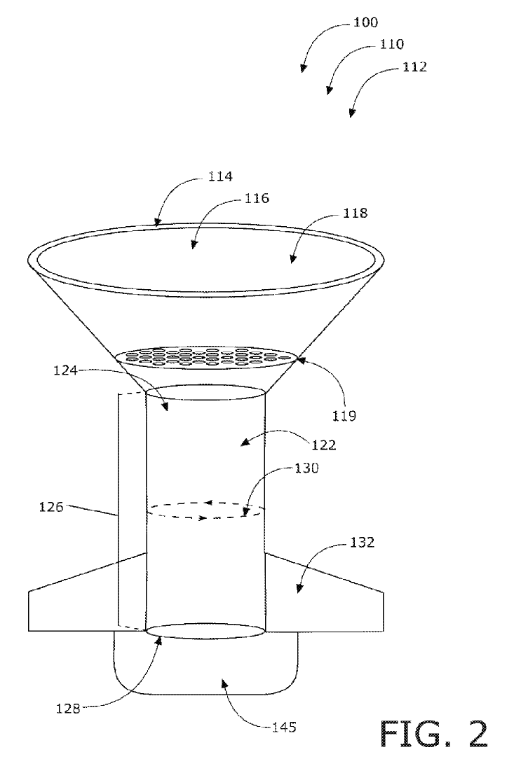

FIG. 2 is a side perspective, cutaway view illustrating the no-back-wash-colander assembly 110 of FIG. 1, comprising a sieve such as conical-colander 112 (here having strainer or screen 119), a stem 122, and a base 132 leading into a sink drain 145 according to an embodiment of the present disclosure.

As illustrated, the no-back-wash-colander assembly 110 may include a conical-colander 112 having a top-opening 114, a conical-wall 116, and an inner volume 118, collectively configured to receive liquids, solids, or a combination thereof, poured into the sieve having separator 119, which here is embodied as a grid frame drain, which may be comprised of stainless steel. This may provide the benefit of preventing edibles from contamination where said strainer 119 allows liquid to pass through to a bottom-opening 120, while preventing the comestibles from passing through. According to one embodiment, the no-back-wash-colander assembly 110 may further include a stem 122 having an upper-end 124, a length 126, a lower-end 128, and a circumference 130.

According to one embodiment, the stem 122 may be removably insertable into a drain of a kitchen sink, with the sink having an opening or funnel, and wherein said funnel has an inverted taper to allow liquids to pass through into a drain of a kitchen sink 145. The no-back-wash-colander assembly 110 may further include a base 132 that is removeably-coupleable with said stem 122, and where said base 132 includes an anchor to promote vertical stability. Here, the base 132 is shown with two legs, but other embodiments are contemplates including greater that two “legs” (e.g., 3, 4, etc.), a “continuous” base or base lacking discontinuities (e.g., disc shaped), and the like, which may also be removably coupleable, fixed to, and/or integrated with the riser or stem 122 of the sieve (e.g., conical colander 112).

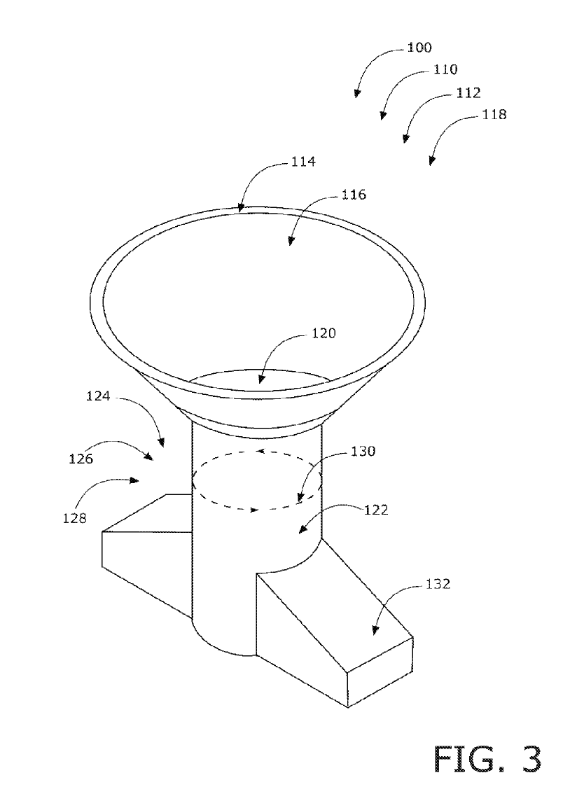

FIG. 3 is a perspective view illustrating the no back wash colander system 100 according to an embodiment of the present disclosure. Here, the no back wash colander system 100 includes a no-back-wash-colander assembly 110 comprising a conical-colander 112 having a top-opening 114, a conical-wall 116, and an inner volume 118, and configured to receive liquids, solids or a combination thereof. The no-back-wash-colander assembly 110 may further include a stem 122 having an upper-end 124, a length 126, a lower-end 128, and a circumference 130. The length 126 may be configured to provide sufficient elevation from a sink bed such that a liquid being separated from the sieve will not be able to reach the sieve or edibles as back wash in the sink. According to one embodiment, the length 126 may be approximately 6 inches. According to another embodiment, the length 126 may be based on a quantity of liquid that the colander is capable of carrying. For example, a hemispherical colander may be configured to have a higher elevation than conical-colander 112, reflecting a greater volumetric capacity.

According to one embodiment, the stem 122 may be removably insertable into a drain of a kitchen sink, which comprises an opening, recessed area, or funnel. In particular, the a lower-end 128 of the stem 122 may be fixedly or adjustably configured to extend below the base 132 and “seat” into at least a portion of the sink drain (see e.g., FIG. 2). For example, where the funnel has an inverted taper to allow liquids to pass through into a drain of a kitchen sink, the stem 122 may include a mating taper. Alternately, as illustrated here, the base 132, which may be removably-coupleable (or fixed) with said stem 122, may be configured such that its lower end 128 is substantially flush said the bottom of base 132, where base 132 is configured as an anchor to promote vertical stability, for example, for use with drains that are substantially flush with a flat-bottomed sink.

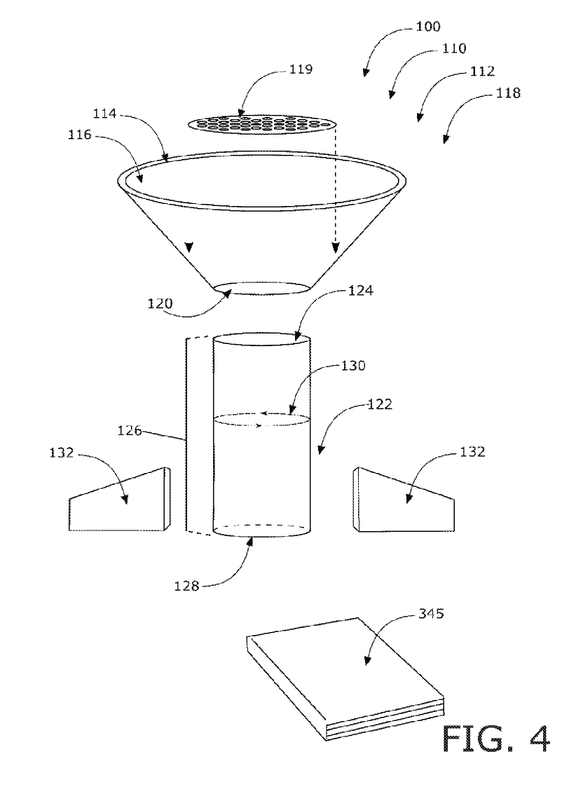

FIG. 4 is an exploded view illustrating the no back wash colander system 100 comprising the no back wash colander assembly 110 including a screen 119, according to an embodiment of the present disclosure. Here, the no back wash colander system 100 may be adaptable as a kit, where the no-back-wash-colander assembly 110 is separable (and reassembleable) into a conical sieve 112 which includes a detachable stainless steel grid frame (screen 119), detachable base legs 132, and detachable stem 122.

It should be noted that the no back wash colander system 100 may be sold as a kit 340 comprising the following parts: at least one conical-colander 112, at least one heat-resistant handle 115, at least one strainer screen 119, at least one stem 122, at least one base 132, and at least one set of user instructions 345. The kit 340 has instructions such that functional relationships are detailed in relation to the structure of the device (such that the device/system can be used, maintained, assembled/disassembled, or the like, in a preferred manner). The no back wash colander system 100 may be manufactured and provided for sale in a wide variety of sizes and shapes for a wide assortment of sinks and applications.

Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

It should be noted that the steps described in the method of use can be carried out in many different orders according to user preference. The use of “step of” should not be interpreted as “step for”, in the claims herein and is not intended to invoke the provisions of 35 U.S.C. § 112(f). Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the disclosure described herein are exemplary and numerous modifications, variations and rearrangements can be readily envisioned to achieve substantially equivalent results, all of which are intended to be embraced within the spirit and scope of the disclosure. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An elevated colander-for evading back wash, the elevated colander comprising:
a conical-colander having a top-opening, a plurality of heat-resistant handles, a conical-wall, an inner volume, a liquid separator, and a liquid discharge opening;
a stem having an upper-end a length, a lower-end, and a circumference; and
a base;
wherein said conical-colander, said stem, and said base are in functional and structural combination; and
wherein said elevated colander is structured and arranged to independently set in a sink bottom such that, when a liquid is poured into said elevated colander, the liquid is discharged from the elevated colander without coming back into contact with said inner volume, and said elevated colander remains in an upright orientation.

2. The elevated colander of claim 1, wherein said liquid separator and said liquid discharge are combined as single unit.

3. The elevated colander of claim 2, wherein said liquid separator includes a grid frame.

4. The elevated colander of claim 3, wherein said grid frame is configured to allow said liquid to pass through yet prevent comestibles from passing through.

5. The elevated colander of claim 4, wherein said top-opening has an upper diameter, and said bottom-opening has a lower diameter, said upper diameter being larger than said lower diameter.

6. The elevated colander of claim 5, wherein said heat-resistant handles are fixed to said top-opening.

7. The elevated colander of claim 6, wherein said base includes at least one leg.

8. The elevated colander of claim 7, wherein said at least one leg is fixedly-attached to said stem, extending radially from a center axis of said stem.

9. The elevated colander of claim 8, wherein said stem is removeably-insertable into a drain of a sink.

10. The elevated colander of claim 9, wherein said conical-colander comprises a funnel.

11. The elevated colander of claim 10, wherein said funnel comprises an inverted taper.

12. The elevated colander of claim 11, wherein said grid frame is made of stainless steel.

13. The elevated colander of claim 12, wherein said conical-colander is removeably-coupleable with said stem.

14. The elevated colander of claim 13, wherein said stem is removeably-coupleable with said base.

15. The elevated colander of claim 14, wherein said base is configured to provide vertical stability when said conical-colander is filled.

16. The elevated colander of claim 15, wherein said base is configured to prevent side-to-side movement of said elevated colander.

17. The elevated colander of claim 16, wherein said conical-wall is solid.

18. The elevated colander of claim 17, wherein said stem is hollow and configured to allow said liquid to pass through.

19. A no-back-wash-colander-system comprising:
a conical-colander having
a top-opening,
heat-resistant handles,
a conical-wall,
an inner volume,
a screen configured to pass liquids, and
a bottom-opening;
a stem having
an upper-end,
a length,
a lower-end, and
a circumference; and
a base;
wherein said conical-colander, said stem, and said base are in functional and structural combination;
wherein said conical-colander is defined by said top-opening, said heat-resistant handles, said conical-wall, said inner volume, said screen and said bottom-opening,
wherein said stem is defined by said upper-end, said length, said lower-end, and said circumference; and
wherein said no-back-wash-colander-assembly is structured and arranged such that it is able to be independently set in a sink bottom such that when liquid is poured into said sink bottom through said no-back-wash-colander-assembly a sanitary environment for comestibles is provided.

20. The no-back-wash-colander-system of claim 19 further comprising a set of user instructions; and
wherein the conical-colander, stem, the base and the set of user instructions are arranged as a kit.
